(19) United States
(12) Patent Application Publication
(10) Pub. No.: US 2004/0021987 A1
(43) Pub. Date: Feb. 5, 2004

(54) Flying head slider and information recording and/or reproducing device

(75) Inventors: Michio Yotsuya, Kanagawa (JP); Toshio Mamiya, Tokyo (JP); Kazushige Kawazoe, Kanagawa (JP); Koji Fukumoto, Kanagawa (JP); Kazuyuki Yamamoto, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/395,058

(22) Filed: Mar. 25, 2003

(30) Foreign Application Priority Data
Apr. 3, 2002 (JP) 2002-101275

(51) Int. Cl. G11B 5/60

(52) U.S. Cl. 360/235.8

(57) ABSTRACT

Disclosed herein is a flying head slider having an air bearing surface forming portion opposed to a recording medium and adapted to receive a buoyancy produced by air bearing due to a dynamic pressure between the air bearing surface forming portion and a recording surface of the recording medium. The flying head slider includes a head for recording and/or reproducing information, a head mounting portion formed on the air bearing surface forming portion for mounting the head, and a projection of diamond-like carbon provided on the head mounting portion at the upstream side of air flow, which is along the slider, on said head. By providing the projection at the upstream side of air flow on the head, the penetration and deposition of any disturbance such as lubricant and dust to the head can be minimized to thereby prevent damage to the head. Accordingly, the operation reliability of the slider can be improved. Further, an information recording and/or reproducing device including this slider can also be provided.

### BACKGROUND OF THE INVENTION

The present invention relates to a flying head slider having a head, and also relates to an information recording and/or reproducing device having this flying head slider.

A hard disk drive (HDD) as an example of an information recording and/or reproducing device is built in or externally connected to electronic equipment capable of recording and/or reproducing information, such as a portable computer.

FIG. 10 shows a hard disk drive 1000 in the prior art. This hard disk drive 1000 is a so-called fixed hard disk drive. That is, the hard disk drive 1000 has a housing 1001 and a magnetic disk (hard disk) 1002 built in the housing 1001. The magnetic disk 1002 is rotationally driven at a constant angular velocity by a spindle motor (not shown).

A voice coil 1005 is mounted on an arm 1004 at one end thereof, and a suspension 1007 is mounted on the other end of the arm 1004. A slider 1006 including a magnetic head 1020 (see FIG. 11) is mounted on the suspension 1007 at a front end thereof. The voice coil 1005 is interposed between a pair of magnets 1010 and 1012 opposed to each other. The voice coil 1005 and the magnets 1010 and 1012 constitute a voice coil motor.

When a current is passed through the voice coil 1005, a force is applied from the magnetic fields of the magnets 1010 and 1012 to the voice coil 1005, so that the arm 1004 is rotated around the shaft 1014. Accordingly, the magnetic head 1020 of the slider 1006 shown in FIG. 11 moves in a substantially radial direction of the magnetic disk 1002, i.e., in a seek direction to magnetically record information on a given track of the magnetic disk 1002 or to magnetically reproduce information recorded on the magnetic disk 1002.

In the hard disk drive 1000, the magnetic head 1020 is integrated with the slider 1006 having an air bearing surface, so as to avoid the wear and damage to the magnetic head 1020 due to the contact of a surface (magnetic recording and/or reproducing surface) of the magnetic disk 1002 and the magnetic head 1020. Accordingly, the magnetic head 1020 can record information to the surface of the magnetic disk 1002 or reproduce information recorded on the surface of the magnetic disk 1002 in the condition where the magnetic head 1020 is not in contact with the surface of the magnetic disk 1002.

FIG. 12 shows an example of the shape of the slider 1006. The slider 1006 has a pair of rails 1030. When the magnetic disk 1002 is rotated in a direction shown by arrow 1031 in FIG. 11, an air flow is produced between the surface of the magnetic disk 1002 and the slider 1006, so that the rails 1030 receives a buoyancy (air pressure) from the air flow. Accordingly, the magnetic head 1020 mounted on the slider 1006 flies above the surface of the rotating magnetic disk 1002 thereby generating a microscopic space (flying amount or flying height) 1040 thereof as shown in FIG. 13. This flying height 1040 is usually about 20 nm, for example, and it can be reduced to about 10 nm.

The hard disk drive 1000 is a so-called flying head type hard disk drive having a flying magnetic head. As shown in FIG. 13, the slider 1006 can correspond with a certain level of undulation 1070 (shown in FIG. 13) on the surface of the magnetic disk 1002, thereby reducing a spacing loss and preventing the wear and damage to the magnetic head 1020.

In response to a recent trend of high-capacity and high-density recording of the hard disk drive, an MR (magneto-resistive) head has made a greatest contribution. The MR head can sensitively read even a very weak magnetic signal on a magnetic disk without dependence on the linear velocity of the magnetic disk, thereby realizing high-density recording with the same flying height as the conventional one. However, the MR head is not resistant to static electricity and heat.

For example, when even a minute amount of static electricity is passed through an MR element, there is a possibility that the MR element may be melted to cause the damage to the head. It is therefore necessary to severely avoid the penetration and deposition of any disturbance such as lubricant and dust to the head, especially to the MR head.

### SUMMARY OF THE INVENTION

It is accordingly an object of the present invention to provide a flying head slider, which can minimize the penetration and deposition of any disturbance such as lubricant and dust to the head, thereby preventing damage to the head and improving the operation reliability.

It is another object of the present invention to provide an information recording and/or reproducing device including the flying head slider.

In accordance with an aspect of the present invention, there is provided a flying head slider having an air bearing surface forming portion opposed to a recording medium and adapted to receive a flying force produced by air bearing due to a dynamic pressure between the air bearing surface forming portion and a recording surface of the recording medium, the flying head slider including a head for recording and/or reproducing information; a head mounting portion formed on the air bearing surface forming portion for mounting the head; and a projection of diamond-like carbon provided on the head mounting portion in the upstream side of airflow, which is along the slider, on the head.

With this configuration, the penetration and deposition of any disturbance such as lubricant and dust to the head can be minimized by the projection provided in the upstream side of airflow on the head. Further, the head is prevented from coming into contact with the recording surface of the recording medium by the presence of the projection, thereby improving the operation reliability of the slider.

In accordance with another aspect of the present invention, there is provided an information recording and/or reproducing device including a flying head slider having an air bearing surface forming portion opposed to a recording medium and adapted to receive a buoyancy generated by air bearing due to a dynamic pressure between the air bearing surface forming portion and a recording surface of the recording medium, the information recording and/or reproducing device comprising a head for recording and/or reproducing information; a head mounting portion formed on the air bearing surface forming portion for mounting said head; and a projection of diamond-like carbon provided on the head mounting portion at the upstream side of airflow, which along the slider, on the head. For example, the recording medium is provided as a fixed hard disk or a removable hard disk.

Other objects and features of the invention will be more fully understood from the following detailed description and appended claims when taken with the accompanying drawings.

### BRIEF DESCRIPTION OF THE DRAWINGS

FIG. 1 is a perspective view showing a preferred embodiment of the magnetic information recording and/or reproducing device having a flying head slider according to the present invention;

FIG. 2 is a side view of a slider supported to a suspension of the device shown in FIG. 1;

FIG. 3A is a perspective view of the slider shown in FIG. 2;

FIG. 3B is a cross section taken along the line A-A in FIG. 3A;

FIG. 4 is a plan view of the slider shown in FIG. 3A;

FIG. 5 is an enlarged side view showing the periphery of a magnetic head and a projection of diamond-like carbon of the slider shown in FIG. 3A;

FIG. 6 is an enlarged plan view of an essential part of a flying head slider;

FIG. 7 is an enlarged plan view of an essential part of a flying head slider;

FIG. 8 is an enlarged plan view of an essential part of a flying head slider;

FIG. 9 is a perspective view of a removable hard disk drive as another preferred embodiment of the information recording and/or reproducing device according to the present invention;

FIG. 10 is a perspective view of a hard disk drive in the prior art;

FIG. 11 is a perspective view showing the relation between a slider and a magnetic disk in the hard disk drive shown in FIG. 10;

FIG. 12 is a perspective view of the slider shown in FIG. 11; and

FIG. 13 is a schematic side view showing the flying height of the slider shown in FIG. 11.

### DETAILED DESCRIPTION OF THE PREFERRED EMBODIMENTS

Some preferred embodiments of the present invention will now be described in detail with reference to the attached drawings.

The preferred embodiments of the present invention are merely illustrative and they include various technically preferable limitations. However, the present invention is not limited to these preferred embodiments unless otherwise specified in the following description.

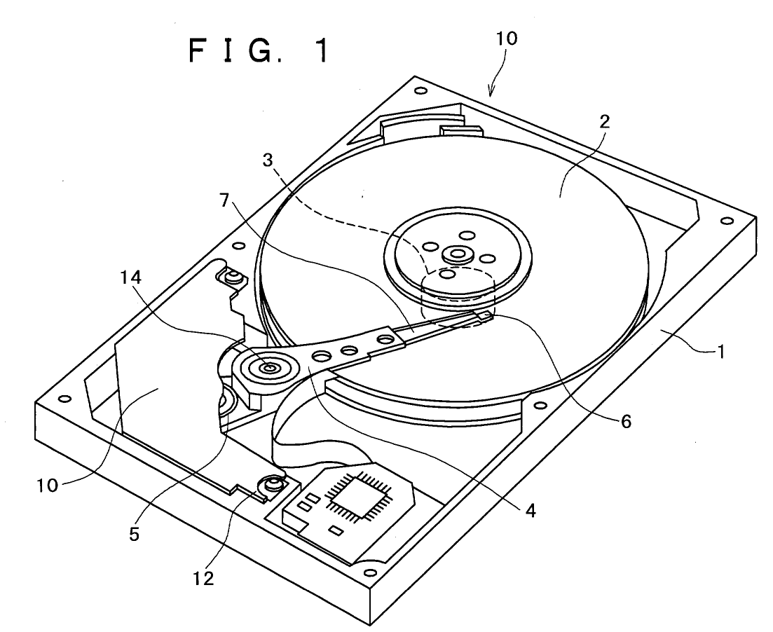

FIG. 1 shows a preferred embodiment of the information recording and/or reproducing device having the flying head slider according to the present invention.

The information recording and/or reproducing device shown in FIG. 1 is a hard disk drive (HDD) 10. The hard disk drive 10 has a housing 1 and a magnetic disk 2 accommodated in the housing 1. The magnetic disk 2 is a kind of recording medium, and it is so called a hard disk (HD). The magnetic disk 2 is rotationally driven at a constant angular velocity by a spindle motor 3.

A voice coil 5 is mounted on an arm 4 at one end thereof, and a suspension 7 is mounted on the other end of the arm 4. A flying head slider (which will be hereinafter referred to simply as slider) 6 is mounted on the suspension 7 at a front end thereof.

The voice coil 5 is interposed between a pair of magnets 10 and 12 on each opposite sides. The voice coil 5 and the magnets 10 and 12 constitute a voice coil motor. When a current is passed through the voice coil 5, a force is applied from the magnetic fields of the magnets 10 and 12 to the voice coil 5, so that the arm 4 is rotated around the shaft 14.

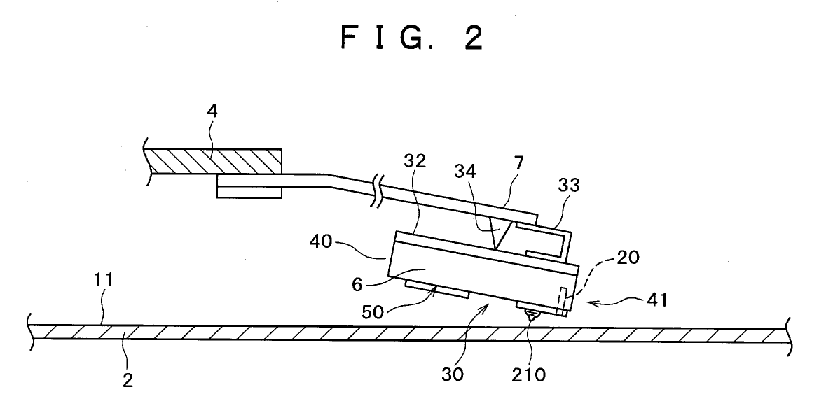

Accordingly, a magnetic head (e.g., MR head) 20 mounted on the slider 6 as shown in FIG. 2 moves above a surface (information recording surface) 11 of the magnetic disk 2 in its substantially radial direction, i.e., in a seek direction to magnetically record information on a given track formed on the surface 11 of the magnetic disk 2 or to magnetically reproduce information recorded on the magnetic disk 2.

The slider 6 has a substantially rectangular prismatic shape, and it includes a disk opposing portion 30 and an upper surface portion 32 opposite to the disk opposing portion 30 as shown in FIG. 2. The disk opposing portion 30 is a portion opposed to the surface 11 of the magnetic disk 2.

As shown in FIG. 2, the upper surface portion 32 is mounted through a gimbal 33 to the front end of the suspension 7, and is supported by a pivot 34 to the suspension 7 at a position behind the gimbal 33. The base end of the suspension 7 is fixed to the arm 4.

The slider 6 has an air inlet end 40 and an air outlet end 41. The air inlet end 40 is also referred to as an air inlet portion or air introducting portion, and the air outlet end 41 is also referred to as an air outlet portion.

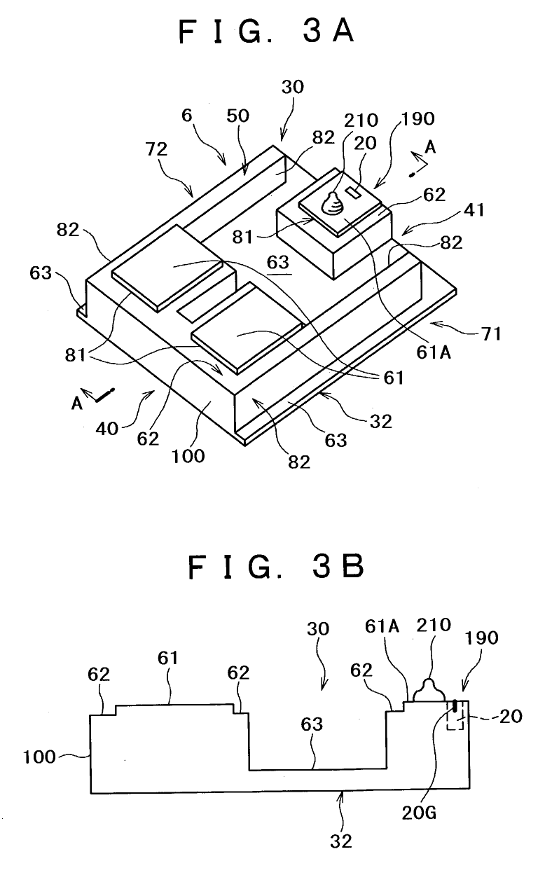

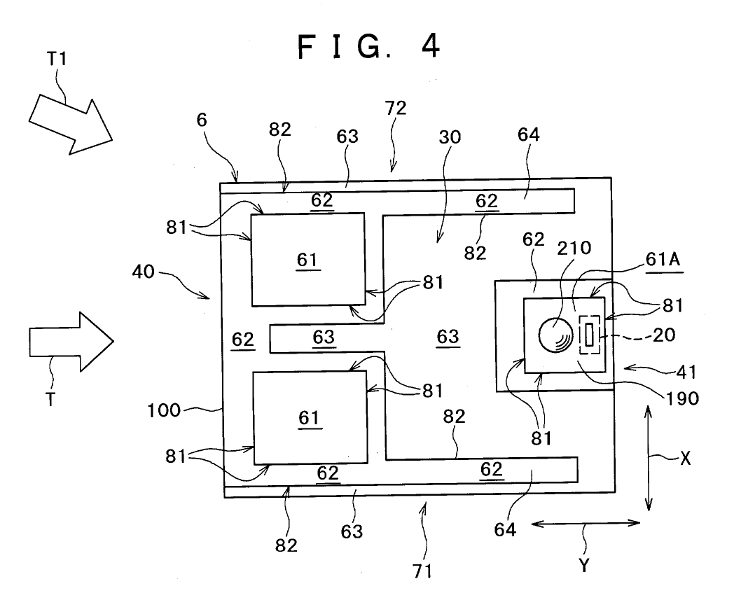

FIGS. 3A, 3B, and 4 show a detailed structure of the slider 6. In particular, FIGS. 3A and 4 are views taken from the side of the disk opposing portion 30 of the slider 6.

In each preferred embodiment, air bearing surfaces of the slider 6 to be hereinafter described are formed by physical dry etching, for example. An air bearing surface forming portion 50 is formed on the disk opposing portion 30 of the slider 6, and an air bearing function generated by a dynamic pressure is provided between the air bearing surface forming portion 50 and the surface 11 of the magnetic disk 2 during rotation of the magnetic disk 2, so that a buoyancy against the slider 6 from the surface 11 of the magnetic disk 2 is generated in a given flying height of the magnetic head 20 from the surface 11 being ensured.

The air bearing surface forming portion 50 for providing the above air bearing function extends from the air inlet end 40 to the air outlet end 41, and includes first air bearing surfaces 61 and 61A, a second air bearing surface 62, and a third air bearing surface 63 each formed by physical dry etching.

As shown in FIG. 4, the first air bearing surfaces 61 and 61A are two rectangular air bearing surfaces 61 formed near the air inlet end 40 and one rectangular air bearing surface 61A formed near the air outlet end 41. The second air bearing surface 62 is so formed as to have a pair of side rail portions 64 and to have regions surrounding the first air bearing surfaces 61 and 61A.

The slider 6 has a first side portion 71 and a second side portion 72 on the opposite sides, and the third air bearing surface 63 is so formed as to have a region defined between the first side portion 71 and one of the side rail portions 64, a region defined between the second side portion 72 and the other side rail portion 64, and a region surrounded by the other portion of the second air bearing surface 62.

As best shown in FIG. 3B, the first air bearing surfaces 61 and 61A are in the highest level as viewed from the disk opposing portion 30. In other words, the first air bearing surfaces 61 and 61A are in the lowest level as viewed from the upper surface portion 32.

More specifically, the second air bearing surface 62 is lowered from the first air bearing surfaces 61 and 61A, and toward the upper surface portion 32 by the height of a first vertical wall 81 as viewed from the disk opposing portion 30. The third air bearing surface 63 is lowered from the second air bearing surface 62, and toward the upper surface portion 32 by the height of a second vertical wall 82 as viewed from the disk opposing portion 30.

A head mounting portion 190 is formed on the first air bearing surface 61A, and the magnetic head 20 is mounted on the head mounting portion 190 (more specifically, the magnetic head 20 is embedded in the head mounting portion 190).

Thus, the air bearing surface forming portion 50 of the slider 6 includes the first air bearing surfaces 61 and 61A, the second air bearing surface 62, and the third air bearing surface 63 having three different levels.

The first air bearing surfaces 61 and 61A are also referred to as rails or pads occasionally depending upon their shapes.

The second air bearing surface 62 is also referred to a step or TPC (Transverse Pressure Contour).

The third air bearing surface 63 is also referred to as a vacuum groove because this surface functions to generate a vacuum.

An end surface portion 100 is formed at the air inlet end 40 so as to vertically extend between the second air bearing surface 62 and the upper surface portion 32.

In other words, the air inlet end 40 is formed by only the vertical end surface portion 100, and the third air bearing surface 63 is not formed at the air inlet end 40. Accordingly, any disturbance such as lubricant and dust entering the air inlet end 40 in an air flow direction T or T1 shown in FIG. 4 is not deposited on the end surface portion 100.

The air flow direction T or T1 is determined by a mounting direction of the slider 6 with respect to the suspension 7 shown in FIG. 2. As shown in FIG. 4, the air flow direction T is a direction parallel to the Y direction, and the air flow direction T₁ is a direction inclined against the Y direction.

In a conventional slider, the third air bearing surface 63 is often formed also at the air inlet end 40, so as to reduce an influence of machining tolerances. However, if the third air bearing surface 63 is formed at the end surface portion 100, an opening area defined in flying the slider 6 becomes large, causing a problem that an increased amount of disturbance such as lubricant and dust may be deposited on the third air bearing surface 63. In this respect, the end surface portion 100 at the air inlet end 40 shown in FIGS. 3A, 3B, and 4 is formed with a vertical surface without steps, so that no deposition of disturbance occurs at the end surface portion 100 and the slider 6 can therefore be kept flying in a stable condition during rotation of the magnetic disk 2.

The slider 6 according to this preferred embodiment has the following especially characteristic points. As shown in FIGS. 3A, 3B, and 4, the first air bearing surface 61A formed near the air outlet end 41 has the head mounting portion 190, and for example, the magnetic head 20 is embedded in the head mounting portion 190. The magnetic head 20 has a head gap 20G as shown in FIG. 3B.

A projection or wall 210 of diamond-like carbon is formed on the head mounting portion 190 at the immediate upstream side of air flow from the air inlet end 40 toward the air outlet end 41. In this preferred embodiment, the projection 210 is in substantially a circular conical shape, and projects from the first air bearing surface 61A in a direction perpendicular thereto as referred to FIG. 4.

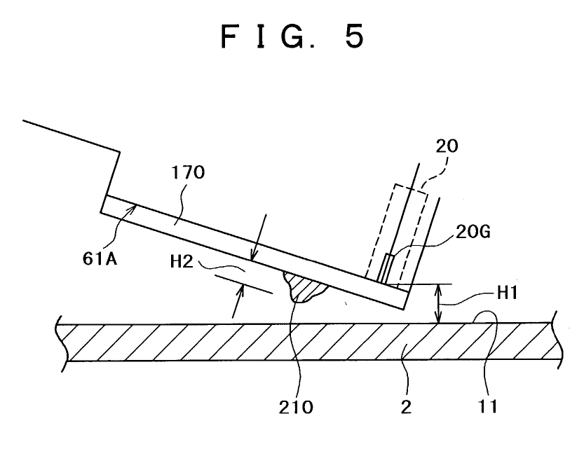

FIG. 5 shows the periphery of the projection 210 and the magnetic head 20. Reference symbol H1 denotes the flying height between the surface 11 of the magnetic disk 2 and the head gap 20G of the magnetic head 20, and reference symbol H2 denotes the height of the projection 210. The height H2 of the projection 210 is set smaller than the flying height H1. Accordingly, the possibility of contact between the projection 210 and the surface 11 of the magnetic disk 2 can be reduced to thereby protect the information recorded on the surface 11 of the magnetic disk 2.

As shown in FIG. 5, a hard film 170 of diamond-like carbon is formed on the first air bearing surface 61A. Although not shown, the hard film 170 is also formed on the first air bearing surfaces 61, the second air bearing surface 62, and the third air bearing surface 63. In other words, the hard film 170 is formed on the entire surface of the air bearing surface forming portion 50 of the slider 6.

Here, the hard film 170 is formed to prevent damage to the air bearing surface forming portion 50 of the slider 6 due to accidental contact between the magnetic disk 2 and the slider 6.

As mentioned above, the projection 210 is formed on the head mounting portion 190 at the upstream side of air flow from the air inlet end 40 toward the air outlet end 41. Accordingly, the penetration and deposition of any disturbance such as lubricant and dust to the magnetic head 20 can be minimized. Furthermore, even when the slider 6 is vibrated because of any disturbance, the projection 210 first comes into contact with the surface 11 of the magnetic disk 2, so that the probability of contact between the magnetic head 20 and the surface 11 of the magnetic disk 2 can be reduced.

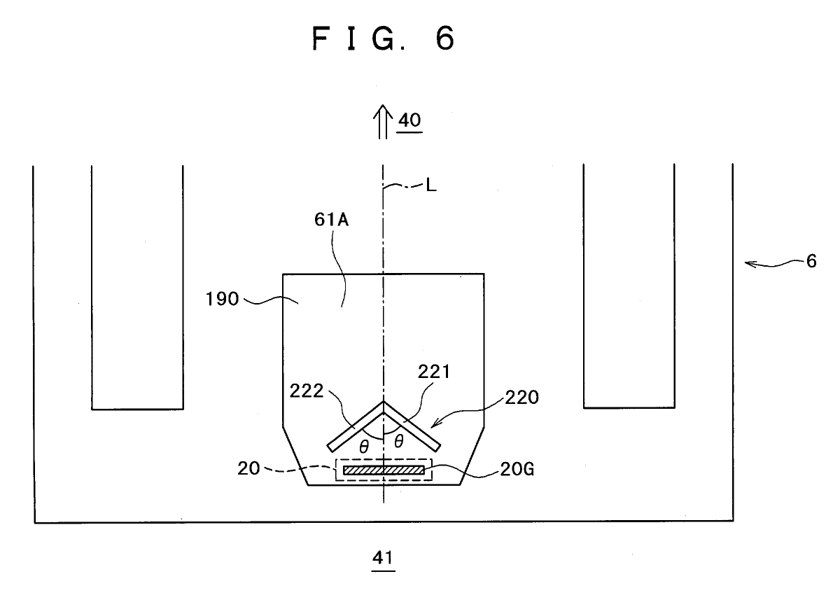

FIG. 6 shows a second preferred embodiment of the flying head slider according to the present invention. In this preferred embodiment, a V-shaped projection or wall 220 of diamond-like carbon is formed on the head mounting portion 190, or the first air bearing surface 61A of the slider 6 at the upstream side of air flow T or T₁, which is from the air inlet end 40 toward the air outlet end 41. The V-shaped projection 220 is pointed toward the air inlet end 40, and is arranged in symmetry against the reference line L parallel to the airflow.

The projection 220 is composed of a first portion 221 inclined up to a given angle θ with respect to the reference line L and a second portion 222 inclined up to the given angle θ against the reference line L opposite to the first portion 221. That is, the first portion 221 and the second portion 222 of the projection 220 are symmetrical against the reference line L and having the same length.

By arranging the projection 220 having such a specific shape positioned in the upstream side of airflow on the magnetic head 20, the penetration and deposition of any disturbance such as lubricant and dust to the magnetic head 20 can be prevented more effectively. Furthermore, even when the slider 6 is vibrated because of any disturbance, the projection 220 first comes into contact with the surface 11 of the magnetic disk 2, so that the probability of contact of the magnetic head 20 and the surface 11 of the magnetic disk 2 can be reduced.

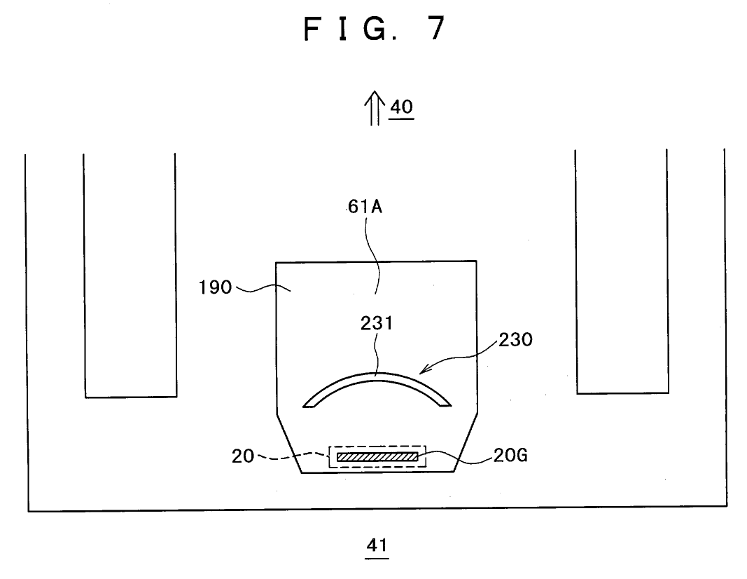

FIG. 7 shows a third preferred embodiment of the flying head slider according to the present invention. In this preferred embodiment, an arcuate projection or wall 230 of the diamond-like carbon is formed on the first air bearing surface 61A of the slider 6 at immediately upstream side of the airflow T and T₁ on the magnetic head 20. The arcuate projection 230 is convex toward the air inlet end 40. By arranging the projection 230 having such a specific shape positioned in the upstream side of the airflow on the magnetic head 20, the penetration and deposition of any disturbance such as lubricant and dust to the magnetic head 20 can be prevented more effectively. Furthermore, even when the slider 6 is vibrated because of any disturbance, the projection 230 first comes into contact with the surface 11 of the magnetic disk 2, so that the probability of contact between the magnetic head 20 and the surface 11 of the magnetic disk 2 can be reduced.

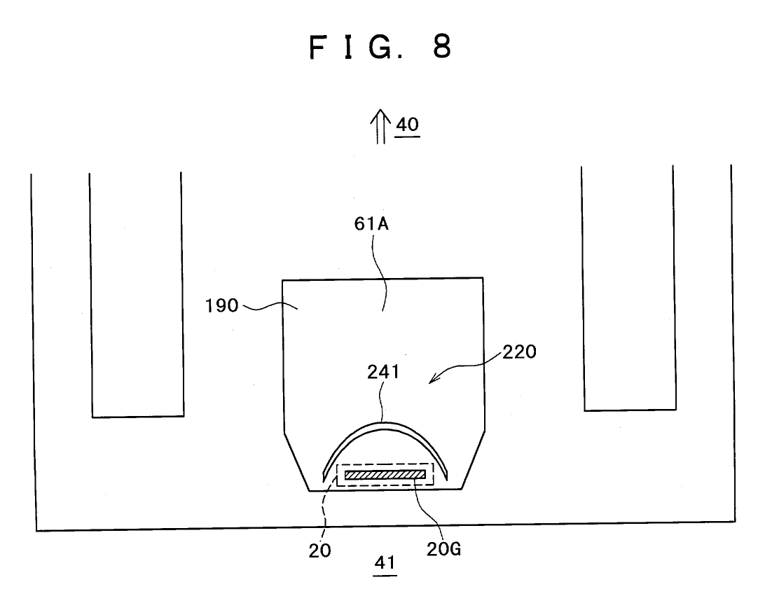

FIG. 8 shows a fourth preferred embodiment of the flying head slider according to the present invention. In this preferred embodiment, a substantially arcuate projection or wall 240 of diamond-like carbon is formed on the head mounting portion 190, or on the first air bearing surface 61A of the slider 6 immediately in front of the upstream side of the airflow from the air inlet end 40 toward the air outlet end 41, on the magnetic head 20. The substantially arcuate projection 240 is convex against the air inlet end 40, and it is arranged closer to the magnetic head 20 than the projection 230 shown in FIG. 7 so as to cover the magnetic head 20. Accordingly, the penetration and deposition of any disturbance such as lubricant and dust to the magnetic head 20 can be prevented more effectively as compared with the preferred embodiment shown in FIG. 7. Furthermore, even when the slider 6 is vibrated because of any disturbance, the projection 240 first comes into contact with the surface 11 of the magnetic disk 2, so that the probability of contact between the magnetic head 20 and the surface 11 of the magnetic disk 2 can be reduced.

In each preferred embodiment mentioned above, the slider 6 is applied to a fixed hard disk drive, i.e., the magnetic disk 2 is not removable.

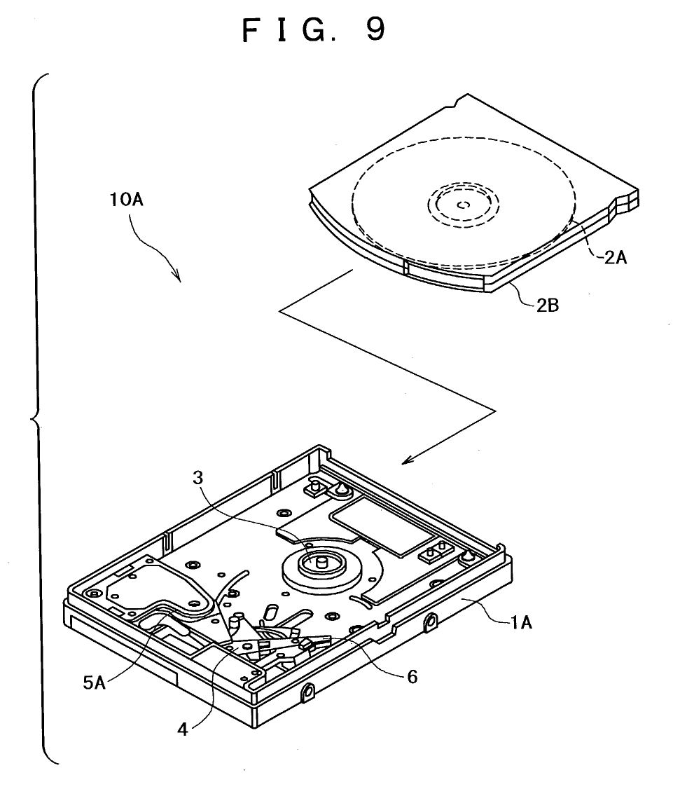

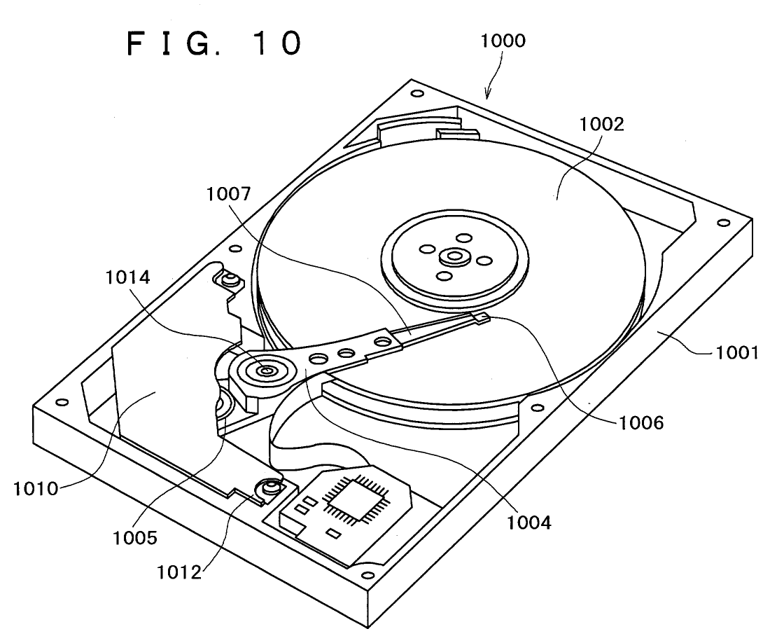

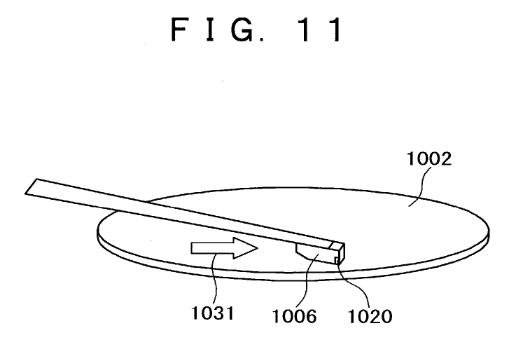

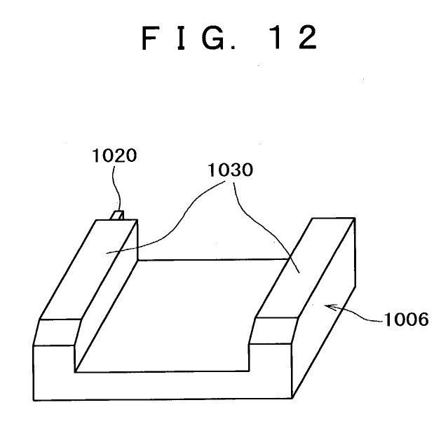

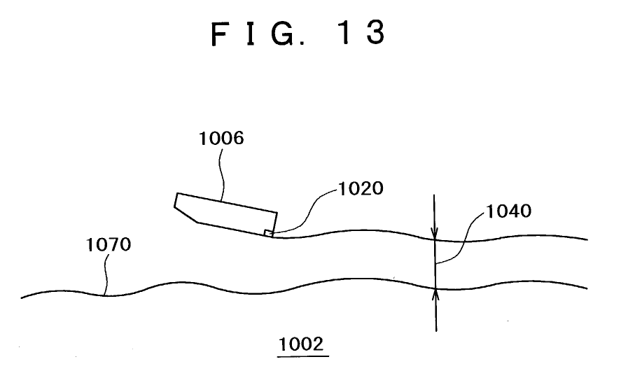

In contrast thereto, a removable hard disk drive 10A as another preferred embodiment of the information recording and/or reproducing device according to the present invention is shown in FIG. 9. The removable hard disk drive 10A includes a housing 1A, a spindle motor 3, an arm 4, a slider 6, and a voice coil motor 5A each accommodated in the housing 1A. A magnetic disk (e.g., hard disk) 2A is accommodated in a case 2B. The case 2B is adapted to be removably mounted into the housing 1A of the removable hard disk drive 10A.

When the magnetic disk 2A accommodated in the case 2B is loaded in the housing 1A, the magnetic disk 2A is continuously rotated by the spindle motor 3. The arm 4, the slider 6, and the voice coil motor 5A are similar in structure to those shown in FIG. 1, so the description thereof will be omitted herein.

The removable hard disk drive 10A is built or mounted particularly in small-sized electronic equipment such as a notebook personal computer and a PDA (Portable Digital Assistant). The removable hard disk drive 10A has a merit that the case 2B containing the magnetic disk 2A can be removably mounted into the housing 1A.

The flying head slider according to the present invention is applicable also to the removable hard disk drive 10A.

The information recording and/or reproducing device having the flying head slider according to the present invention includes not only a hard disk drive, but also a magneto-optical recording and/or reproducing device for recording and/or reproducing information on a magneto-optical disk (MO disk) inclusive of a mini-disc (MD).

The flying head slider according to the present invention may include an optical head for recording and/or reproducing information on an optical disk. An information recording and/or reproducing device having this flying head slider is also referred to as an optical recording and/or reproducing disk drive. The optical head mounted on this slider has optical elements such as an objective lens for focusing light on the disk and passing reflected light from the disk.

The present invention can be applied to any slider including a recording and/or reproducing head for a magnetic disk, magneto-optical disk, or optical disk. Further, the present invention can be generally applied to any technique using a flying mechanism.

According to the slider of the present invention, the projection of diamond-like carbon is provided preferably right in front of the upstream side of airflow T and T₁ on the magnetic head, thereby preventing the penetration and deposition of any disturbance such as lubricant and dust to the magnetic head.

In particular, the penetration and deposition of any disturbance such as lubricant and dust to a brittle MR element of the head can be prevented. Accordingly, by using the slider of the present invention, the MR element can be protected from any disturbance and it is therefore possible to provide a hard disk drive having high reliability.

According to the present invention as described above, the projection of diamond-like carbon is provided at the upstream side of airflow, which is along the slider, on the head mounted on the head mounting portion, thereby minimizing the penetration and deposition of any disturbance such as lubricant and dust to the head. Accordingly, the head can be protected from damage due to such a disturbance, thereby improving the operation reliability of the slider.

While the invention has been described with reference to specific embodiments, the description is illustrative and is not to be construed as limiting the scope of the invention. Various modifications and changes may occur to those skilled in the art without departing from the spirit and scope of the invention as defined by the appended claims.

What is claimed is:

1. A flying head slider having an air bearing surface forming portion opposed to a recording medium and adapted to receive a buoyancy generated from air bearing due to a dynamic pressure between said air bearing surface forming portion and a recording surface of said recording medium comprising:
a head for recording and/or reproducing information;
a head mounting portion formed on said air bearing surface forming portion for mounting said head; and
a projection of diamond-like carbon provided on said head mounting portion at the upstream side of airflow which is along said slider, on said head.

2. A flying head slider according to claim 1, wherein the height of said projection is shorter than the flying height of a head gap portion of said head flying above said recording surface of said recording medium.

3. A flying head slider according to claim 1, wherein said projection has a circular conical shape.

4. A flying head slider according to claim 1, wherein said projection comprises a first portion inclined against the reference line parallel to said air flow and a second portion inclined against said reference line in symmetrical relationship with said first portion.

5. A flying head slider according to claim 1, wherein said projection has an arcuate shape convex toward the upstream side of said air flow.

6. An information recording and/or reproducing device including a flying head slider having an air bearing surface forming portion opposed to a recording medium and adapted to receive a buoyancy generated from the air bearing due to a dynamic pressure between said air bearing surface forming portion and a recording surface of said recording medium, said information recording and/or reproducing device comprising:
a head for recording and/or reproducing information;
a head mounting portion formed on said air bearing surface forming portion for mounting said head; and
a projection of diamond-like carbon provided on said head mounting portion at upstream side of air flow, which is along said slider on said head.

7. An information recording and/or reproducing device according to claim 6, wherein the height of said projection is shorrer than the flying height of a head gap portion of said head flying above said recording surface of said recording medium.

8. An information recording and/or reproducing device according to claim 6, wherein said projection has a circular conical shape.

9. An information recording and/or reproducing device according to claim 6, wherein said projection comprises a first portion inclined against the reference line parallel to said air flow and a second portion inclined against said reference line in symmetrical relationship with said first portion.

10. An information recording and/or reproducing device according to claim 6, wherein said projection has an arcuate shape convex toward the upstream side of said air flow.

11. An information recording and/or reproducing device according to claim 6, wherein said recording medium comprises a fixed hard disk.

12. An information recording and/or reproducing device according to claim 6, wherein said recording medium comprises a removable hard disk.
